(19) United States
(12) Patent Application Publication
(10) Pub. No.: US 2014/0307015 A1
(43) Pub. Date: Oct. 16, 2014

(54) INK CARTRIDGE, INK CARTRIDGE ASSEMBLY, INKJET RECORDING APPARATUS, INK CARTRIDGE INSTALLATION DETECTION MODULE AND INK CARTRIDGE INSTALLATION DETECTION METHOD

(71) Applicant: ZHUHAI NINESTAR MANAGEMENT CO., LTD., Zhuhai (CN)

(72) Inventors: BING NIE, Zhuhai (CN); Zhizheng Jia, Zhuhai (CN); Yuedan Liang, Zhuhai (CN)

(21) Appl. No.: 14/316,440

(22) Filed: Jun. 26, 2014

Related U.S. Application Data
(63) Continuation of application No. PCT/CN2012/087444, filed on Dec. 25, 2012.

(30) Foreign Application Priority Data
Dec. 30, 2011 (CN) 201110460180.8

(51) Int. Cl. B41J 2/175

(52) U.S. Cl. CPC B41J 2/17543
USPC 347/5

(57) ABSTRACT

The present invention provides an ink cartridge, an ink cartridge assembly, an inkjet recording apparatus, an ink cartridge installation detection module and a method. The module comprises a light emitter, a controller, a processing unit and a control unit, wherein the light emitter is configured to provide a light source; the controller includes a receiving unit configured to receive a plurality of ink cartridge installation detection instructions sent by the inkjet recording apparatus via a bus; the processing unit is configured to analyze the ink cartridge installation detection instruction; and the control unit is configured to turn on or off the light emitter according to the analytic result of the processing unit. The present invention improves the universality of the ink cartridges and achieves ink cartridge installation detection with lower cost.

### CROSS REFERENCE TO RELATED APPLICATIONS

This application is a continuation of International Application No. PCT/CN2012/087444, filed on Dec. 25, 2012, which claims priority to China Patent Application No. 201110460180.8 filed with the Chinese Patent Office, on Dec. 30, 2011, entitled “INK CARTRIDGE, INK CARTRIDGE ASSEMBLY, INKJET RECORDING APPARATUS, INK CARTRIDGE INSTALLATION DETECTION MODULE AND INK CARTRIDGE INSTALLATION DETECTION METHOD”, which is hereby incorporated herein by reference in its entirety.

### FIELD OF THE TECHNOLOGY

The present invention relates to the inkjet printing technology, in particular to an ink cartridge, an ink cartridge assembly, an inkjet recording apparatus, an ink cartridge installation detection module and an ink cartridge installation detection method.

### BACKGROUND

Inkjet printer manufacturers tend to set installation detection programs on inkjet printers, namely in the initialization process of the inkjet printer, ink cartridges must be subjected to installation detection to determine that the ink cartridges are mounted at correct positions, so as to avoid print error.

The ink cartridge installation detection principle of the inkjet printer in the prior art is as shown in FIG. 14. Firstly, four ink cartridges are respectively mounted at four ink cartridge mounting positions of the inkjet printer, wherein correct mounting positions corresponding to the ink cartridges Y1, Y2, Y3 and Y4 respectively are X1, X2, X3 and X4. Each ink cartridge is provided with an ink cartridge chip; a light-emitting diode (LED) lamp is disposed on the ink cartridge chip; and a light receiver is disposed on the inkjet printer. When a control circuit of the inkjet printer determines that the ink cartridges are all mounted at the positions, the ink cartridges are progressively moved to positions relative to the light receiver; an instruction for turning on the LED lamp is sent to the ink cartridges; and the instruction includes an ink cartridge ID and an instruction for turning on the LED lamp. All the ink cartridges can receive the instruction, but only the ink cartridge chip of the ink cartridge matched with the ink cartridge ID responds to the instruction and turns on the LED disposed thereon. The light receiver receives light emitted by the LED; the control circuit determines the mounting condition of the ink cartridge according to the light intensity of the light received by the light receiver; if the light intensity of the light received by the light receiver exceeds a default threshold, the ink cartridge passes the detection; an instruction for turning off the LED lamp is sent to the ink cartridge; the next ink cartridge is moved to the position relative to the light receiver, and the above steps are repeated to perform installation detection on the next ink cartridge; the installation detection process is ended until the control circuit determines that the mounting positions of all the ink cartridges are correct; or else, the control circuit determines wrong mounting position of the ink cartridge, sends a warning message and ends the installation detection process.

The inventor found in implementing the prior art that the ink cartridge installation detection in the prior art may at least have defects in two aspects:

In one aspect, from the viewpoint of the inkjet printer, the inkjet printer can only be adapted to specific ink cartridges and cannot be adapted to non-specific ink cartridges which are not provided with LED lamps and cannot respond to on instructions and the like. Therefore, the ink cartridge selection range of users can be limited and the use cost of the users can be increased.

In another aspect, from the viewpoint of the specific ink cartridges, the production cost of the specific ink cartridges is relatively high. Moreover, due to the limitation of the factors such as the settings of the LED lamps and the self functions of the chips, the specific ink cartridges are likely to become disposable products, namely the specific ink cartridges will be discarded after used up. Therefore, not only the use cost of the users can be increased but also recyclable resources such as the LED lamps can be wasted due to the discarding of the specific ink cartridges; and the environmental pollution can be easily caused.

### SUMMARY

The present invention provides an ink cartridge, an ink cartridge assembly, an inkjet recording apparatus, an ink cartridge installation detection module and an ink cartridge installation detection method, which are configured to improve the universality of ink cartridges and achieve the ink cartridge installation detection with lower cost.

In a first aspect, the present invention provides an ink cartridge installation detection module, which comprises:

A light emitter configured to provide a light source; and

A controller including a receiving unit, a processing unit and a control unit, in which the receiving unit is configured to receive a plurality of ink cartridge installation detection instructions sent by an inkjet recording apparatus via a bus; the ink cartridge installation detection instruction includes an emission control instruction and ink cartridge identifying information; the ink cartridge identifying information corresponds to an ink cartridge which must respond to the emission control instruction; the emission control instruction includes an on instruction or an off instruction; the processing unit is configured to analyze the ink cartridge installation detection instruction; and the control unit is configured to turn on or off the light emitter according to the analytic result of the processing unit.

In a second aspect, the present invention provides an ink cartridge, which comprises an ink cartridge body and an ink cartridge chip, wherein the ink cartridge further comprises the foregoing ink cartridge installation detection module; and the ink cartridge installation detection module is detachably mounted on the ink cartridge body; or the ink cartridge installation detection module and the ink cartridge chip are integrated into a whole and detachably mounted on the ink cartridge body.

In a third aspect, the present invention provides an ink cartridge assembly, which comprises an ink cartridge assembly body including at least two ink cartridges, wherein the ink cartridge assembly further comprises the foregoing ink cartridge installation detection module; and the ink cartridge installation detection module is detachably mounted on the ink cartridge assembly body.

In a fourth aspect, the present invention provides an inkjet recording apparatus, which comprises an inkjet recording apparatus body, wherein the inkjet recording apparatus further comprises the foregoing ink cartridge assembly; and the ink cartridge assembly is detachably mounted on the inkjet recording apparatus body.

In a fifth aspect, the present invention provides an ink cartridge installation detection method, which comprises:

Receiving a plurality of ink cartridge installation detection instructions sent by an inkjet recording apparatus via a bus, in which the ink cartridge installation detection instruction includes an emission control instruction and ink cartridge identifying information;

the ink cartridge identifying information corresponds to an ink cartridge which must respond to the emission control instruction; the emission control instruction includes an on instruction or an off instruction;

Analyzing the ink cartridge installation detection instruction; and

Turning on or off a light emitter according to the analytic result of a processing unit.

In the ink cartridge, the ink cartridge assembly, the inkjet recording apparatus, the ink cartridge installation detection module and the ink cartridge installation detection method, in the initialization process of the inkjet recording apparatus, the ink cartridge installation detection module replaces specific ink cartridges to respond to all or partial instructions, relevant to ink cartridge installation detection, sent by the inkjet recording apparatus, so that the present invention not only satisfies the inherent ink cartridge installation detection requirement of the inkjet recording apparatus but also allows ink cartridges without the ability of responding to the installation detection relevant instructions to be adapted to the inkjet recording apparatus. Therefore, the universality of the ink cartridges can be improved; the selection range of ink cartridges adapted to the inkjet recording apparatus can be widened;

and the use cost of the users can be reduced. Moreover, as the ink cartridge installation detection module may be reutilized, the resource utilization can be improved and the cost can be reduced.

### BRIEF DESCRIPTION OF THE DRAWINGS

FIG. 1 is a schematic structural view of an inkjet recording apparatus provided by the present invention;

FIG. 2a is a schematic structural view of an ink cartridge assembly body provided by the present invention;

FIG. 2b is a schematic structural view of a housing of the ink cartridge assembly body provided by the present invention;

FIG. 3 is a schematic structural view of an ink cartridge installation detection module provided by the present invention;

FIG. 4 is a schematic diagram illustrating the interactive mode between the ink cartridge assembly provided by the present invention and a control circuit of the inkjet recording apparatus;

FIG. 5 is a schematic diagram illustrating the emission detection process in the ink cartridge installation detection process provided by the present invention;

FIG. 6 is a structure example of an ink cartridge installation detection instruction provided by the present invention;

FIG. 7 is a schematic structural view of another ink cartridge installation detection module provided by the present invention;

FIG. 8 is a schematic diagram illustrating the interactive mode between another ink cartridge assembly provided by the present invention and the control circuit of the inkjet recording apparatus;

FIG. 9a is a schematic diagram illustrating the installation reply process in the ink cartridge installation detection process provided by the present invention;

FIG. 9b is a schematic diagram illustrating the emission detection process in another ink cartridge installation detection process provided by the present invention;

FIG. 10 is a schematic diagram illustrating the interactive mode between another ink cartridge assembly provided by the present invention and the control circuit of the inkjet recording apparatus;

FIG. 11 is a schematic diagram illustrating the interactive mode between another ink cartridge assembly provided by the present invention and the control circuit of the inkjet recording apparatus;

FIG. 12 is a schematic diagram illustrating the interactive mode between another ink cartridge assembly provided by the present invention and the control circuit of the inkjet recording apparatus;

FIG. 13 is a schematic structural view of an optical transmitter provided by the present invention; and

FIG. 14 is an example of the ink cartridge installation detection process in the prior art.

### REFERENCE NUMERALS OF THE ACCOMPANYING DRAWINGS

1: Inkjet Recording Apparatus Body; 2: Ink Cartridge Assembly; 21: Ink Cartridge Assembly Body; 22: Ink Cartridge Installation Detection Module; a-e: Ink Cartridge; A-E: Ink Cartridge Accommodating Area; 211: Housing; 221: Light Emitter 222: Controller; 2221: Receiving Unit; 2222: Processing Unit; 2223: Control Unit; 2224: Storage Unit; 2225: Optical Transmitter; 22251: Opening.

### DETAILED DESCRIPTION OF EMBODIMENTS

For more clear understanding of the objectives, technical proposals and advantages of the present invention, clear and complete description will be given below to the technical proposals of the embodiments of the present invention with reference to the accompanying drawings of the embodiments of the present invention. It will be obvious to those skilled in the art that the preferred embodiments are only partial embodiments of the present invention but not all the embodiments. All the other embodiments obtained by those skilled in the art without creative efforts on the basis of the embodiments of the present invention shall fall within the scope of protection of the present invention.

The main concept of the present invention is that: an ink cartridge installation detection module is arranged and is detachably connected with an ink cartridge assembly body or an ink cartridge body. The ink cartridge installation detection module is communicated with an inkjet recording apparatus via a bus. In the initialization process of the inkjet recording apparatus, the ink cartridge installation detection module replaces specific ink cartridges to respond to all or partial instructions, relevant to the ink cartridge installation detection, sent by the inkjet recording apparatus, so that the present invention not only satisfies the inherent ink cartridge installation detection requirement of the inkjet recording apparatus but also allows ink cartridges without the ability of responding the installation detection relevant instructions to be adapted to the inkjet recording apparatus. Therefore, the universality of the ink cartridges can be improved; the selection range of ink cartridges adapted to the inkjet recording apparatus can be widened; and the use cost of the users can be reduced. Moreover, as the ink cartridge installation detection module may be reutilized, the resource utilization can be improved and the cost can be reduced.

The serial numbers of the embodiments described below of the present invention are only used for description and do not indicate the merits.

### Embodiment 1

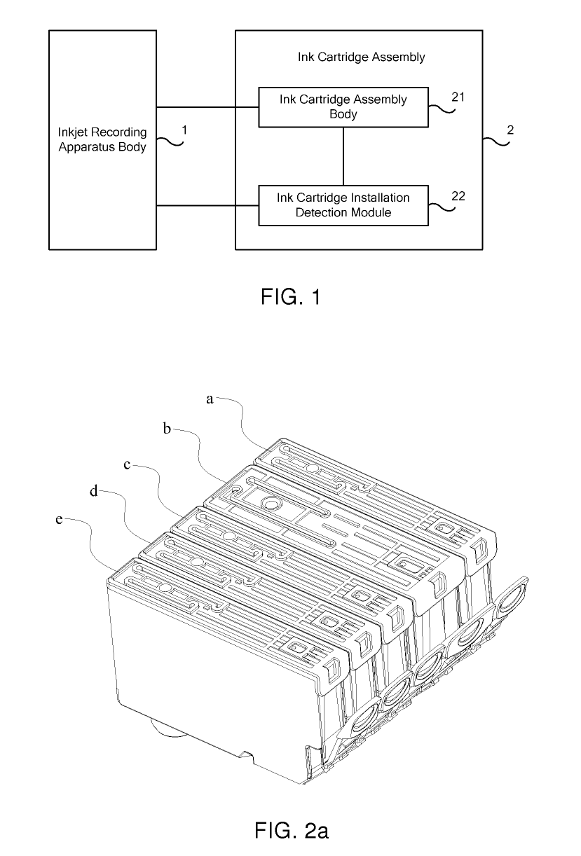

FIG. 1 is a schematic structural view of an inkjet recording apparatus provided by the present invention. The inkjet recording apparatus may specifically be an inkjet printer, an inkjet facsimile machine, an inkjet duplicator or the like. The inkjet recording apparatus as shown in FIG. 1 may comprise an inkjet recording apparatus body 1 and an ink cartridge assembly 2; and the ink cartridge assembly 2 is detachably mounted on the inkjet recording apparatus body 1.

The inkjet recording apparatus body 1 may includes a control circuit, a light receiver and a carriage. The control circuit is configured to integrally control the working process of the inkjet recording apparatus; the light receiver is connected with the control circuit and configured to receive light in the ink cartridge installation detection process; and the carriage is configured to move with the ink cartridge assembly contained so as to guarantee that ink cartridges on the ink cartridge assembly can be moved to a position relative to the light receiver one by one.

The ink cartridge assembly 2 is detachably mounted on the carriage and electrically connected with the control circuit. The ink cartridge assembly 2 may includes an ink cartridge assembly body 21 and an ink cartridge installation detection module 22; and the ink cartridge installation detection module 22 is detachably mounted on the ink cartridge assembly body 21.

The ink cartridge assembly body 21 includes at least two ink cartridges detachably mounted in a housing. The ink cartridge installation detection module 22 and the ink cartridges are communicated with the control circuit of the inkjet recording apparatus body via a bus.

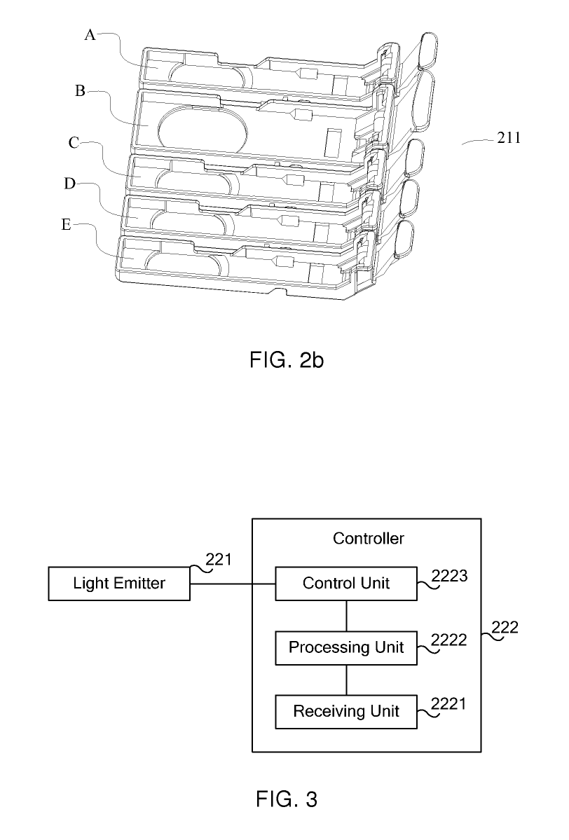

As illustrated in FIG. 21, an optional structure of the ink cartridge assembly body 21 includes a housing 211 and 5 ink cartridges detachably mounted in the housing 211. The 5 ink cartridges may be expressed as ink cartridge a, ink cartridge b, ink cartridge c, ink cartridge d and ink cartridge e. As illustrated in FIG. 2b, the structure of the housing 211 includes accommodating areas of the 5 ink cartridges. The accommodating areas may be expressed as ink cartridge accommodating area A, ink cartridge accommodating area B, ink cartridge accommodating area C, ink cartridge accommodating area D and ink cartridge accommodating area E. The ink cartridges a to e are respectively, correspondingly and detachably mounted in the ink cartridge accommodating areas A, B, C, D and E. The specification of different ink cartridges may be same or different.

As illustrated in FIG. 3, the structure of the ink cartridge installation detection module 22 includes a light emitter 221 and a controller 222 which are connected with each other.

The light emitter 221 is configured to provide a light source. The light source may be a visible or invisible light source.

The controller 222 is configured to receive a plurality of ink cartridge installation detection instructions sent by the inkjet recording apparatus via a bus, analyze the ink cartridge installation detection instruction, and turn on or off the light emitter according to the analytic result of a processing unit.

The controller 222 may include a receiving unit 2221, a processing unit 2222 and a control unit 2223.

The receiving unit 2221 may be configured to receive the plurality of ink cartridge installation detection instructions sent by the inkjet recording apparatus via a bus. The ink cartridge installation detection instruction includes an emission control instruction and ink cartridge identifying information; the ink cartridge identifying information corresponds to an ink cartridge which must respond to the emission control instruction; and the emission control instruction includes an on instruction or an off instruction.

The processing unit 2222 may be configured to analyze the ink cartridge installation detection instruction.

The control unit 2223 may be configured to turn on or off the light emitter according to the analytic result of the processing unit.

The ink cartridge installation detection method of the ink cartridge installation detection module 22 is, for instance, as follows: receiving the plurality of ink cartridge installation detection instructions sent by the inkjet recording apparatus via a bus; analyzing the ink cartridge installation detection instruction; and turning on or off the light emitter according to the analytic result.

More specifically, in the technical proposal provided by the embodiment, the processing unit 2222 may be specifically configured to analyze a part in the ink cartridge installation detection instruction, used for carrying the emission control instruction, so as to acquire the emission control instruction. The control unit 2223 may be specifically configured to turn on or off the light emitter according to the emission control instruction.

That is to say, in the embodiment, the processing unit may ignore the ink cartridge identifying information in the ink cartridge installation detection instruction in the process of analyzing the ink cartridge installation detection instruction; and the control unit turns on or off the light emitter only according to the emission control instruction.

Optionally, the number of the light emitter may be one or more. When the number of the light emitters is numerous, the control unit 2223 may be specifically configured to turn on or off the plurality of light emitters simultaneously according to the comparison result of the processing unit or the acquired emission control instruction.

When the ink cartridge assembly is mounted into the inkjet recording apparatus body, the ink cartridge assembly is electrically connected with the control circuit.

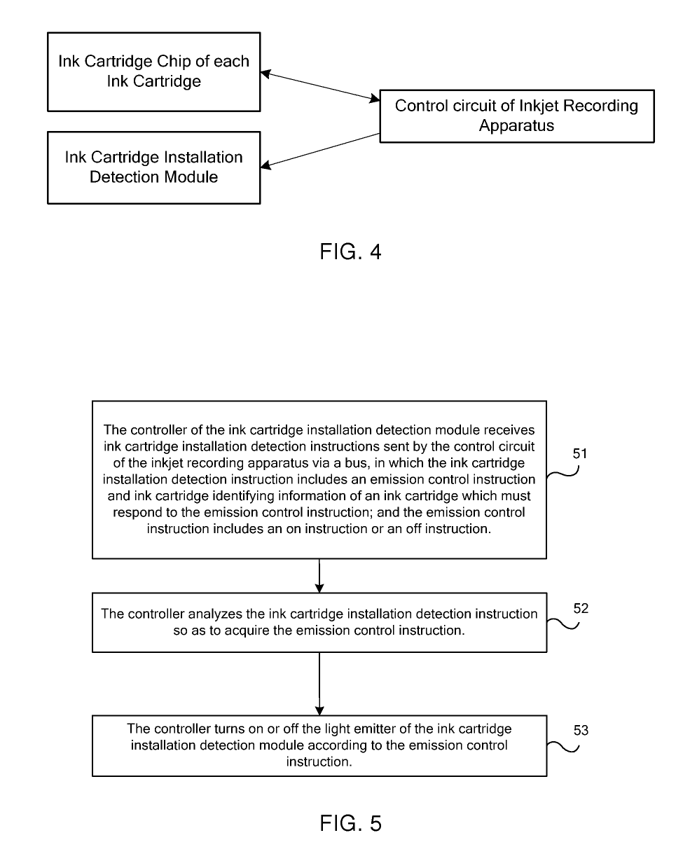

In the embodiment, each ink cartridge may include an ink cartridge body and an ink cartridge chip. The ink cartridge chips of the ink cartridges and the ink cartridge installation detection module may be communicated with the control circuit via a bus. In the initialization process of the inkjet recording apparatus, the interaction between the ink cartridge installation detection module and the ink cartridge chips of the ink cartridges and the control circuit of the inkjet recording apparatus is involved. An example of the interactive mode is as shown in FIG. 4. In this case, the ink cartridge installation detection process may be divided into an installation reply process and an emission detection process. Wherein:

(1) Installation reply process: the two-way interaction between the ink cartridge chips of the ink cartridges and the control circuit of the inkjet recording apparatus is involved, and the interactive mode is the same with that in the prior art. For instance, the installation reply process may include: the control circuit sends ink cartridge installation reply requests to the ink cartridge chips of the ink cartridges in an inkjet ink cartridge assembly, in which the ink cartridge installation reply request includes ink cartridge identifying information corresponding to an ink cartridge which must respond to the ink cartridge installation reply request; the ink cartridge chips receive the ink cartridge identifying information and determine whether the received ink cartridge identifying information is the ink cartridge identifying information thereof; the ink cartridge chips send ink cartridge installation reply responses to the inkjet recording apparatus if so and do not send the ink cartridge installation reply responses if not; and the inkjet recording apparatus continues to execute the emission detection process when receiving reply information of the ink cartridges, or else, output error information and does not continue to execute the subsequent process of the ink cartridge installation detection.

As illustrated in FIG. 2a, the ink cartridge installation reply request sent by the control circuit may include ink cartridge identifying information of the ink cartridges a, b, c, d and e; when an ink cartridge chip of the ink cartridge a receives the request and finds that the request includes the ink cartridge identifying information thereof, the ink cartridge chip will send an ink cartridge installation reply response to the control circuit, and ink cartridge chips of other ink cartridges also perform similar processing; when the control circuit receives the ink cartridge installation reply responses of the 5 ink cartridges, the control circuit determines that the 5 ink cartridges have been installed and continues to execute the subsequent emission detection process; and when the control circuit does not receive the ink cartridge installation reply response of any ink cartridge, the control circuit may output error information and does not continue to execute the subsequent process of the ink cartridge installation detection.

(2) Emission detection process: the one-way interaction between the ink cartridge installation detection module and the control circuit of the inkjet recording apparatus is involved. The control circuit generates and sends ink cartridge installation detection instructions after receiving the ink cartridge installation reply responses of the ink cartridges; the ink cartridge installation detection instructions are transmitted on a bus connected with the control circuit; the ink cartridge chips and the ink cartridge installation detection module connected with the bus can receive all the ink cartridge installation detection instructions; the ink cartridge chips do not perform processing; and the ink cartridge installation detection module performs response processing. The response processing principle is as shown in FIG. 5.

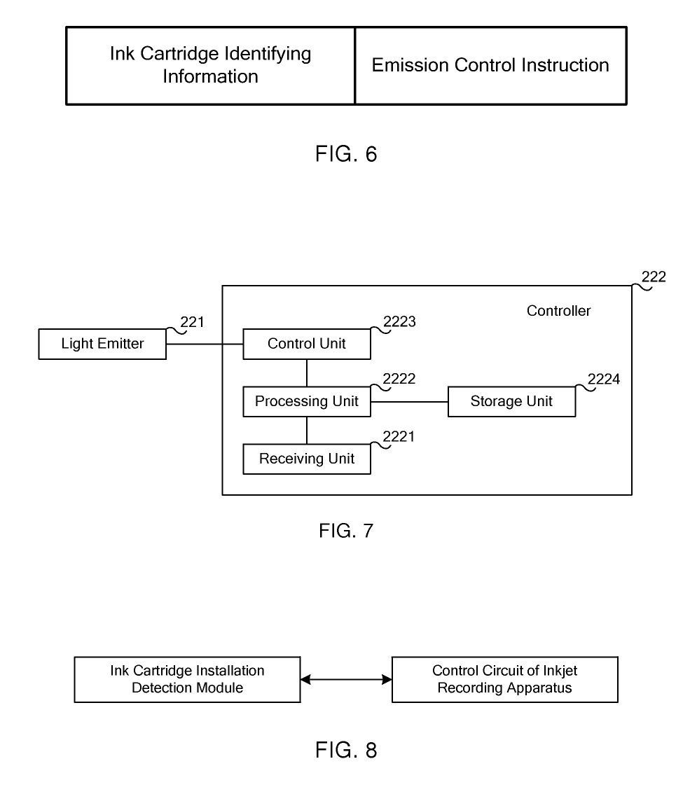

Step 51: The controller of the ink cartridge installation detection module receives the plurality of ink cartridge installation detection instructions sent by the control circuit of the inkjet recording apparatus via the bus. The ink cartridge installation detection instruction includes an emission control instruction and ink cartridge identifying information; the ink cartridge identifying information corresponds to an ink cartridge which must respond to the emission control instruction; and the emission control instruction includes an on instruction or an off instruction.
An optional example of the ink cartridge installation detection instruction is as shown in FIG. 6. The ink cartridge installation detection instruction may include ink cartridge identifying information and an emission control instruction. The ink cartridge identifying information is any identifying information of the ink cartridge which must respond to the emission control instruction, for instance, the ink cartridge ID, the ink color identifier of the ink cartridge and the type identifier of the ink cartridge etc. The emission control instruction may be an on instruction or an off instruction. The on instruction is configured to turn on the light emitter, and the off instruction is configured to turn off the light emitter. The specific expression forms of the emission control instruction are not limited. For instance, in an optional implementation, “000” may be adopted to indicate the off instruction and “100” may be adopted to indicate the on instruction.

Step 52: The controller analyzes a part in the ink cartridge installation detection instruction, used for carrying the emission control instruction, so as to acquire the emission control instruction.
Optionally, the meanings of bits contained in the ink cartridge installation detection instruction may be preset. When the controller receives the ink cartridge installation detection instruction, the controller may only analyze corresponding bits in the instruction, used for carrying the emission control instruction, so as to acquire the emission control instruction.

Step 53: The controller turns on or off the light emitter of the ink cartridge installation detection module according to the emission control instruction.
When the emission control instruction is an on instruction, the controller turns on the light emitter; and when the emission control instruction is an off instruction, the controller turns off the light emitter.

The controller repeats the steps 52 and 53 when receiving an ink cartridge installation detection instruction each time.

When the number of the light emitters is numerous, the controller turns on or off the plurality of light emitters simultaneously according to the emission control instruction.

The above steps may be achieved by means of software. For instance, the controller of the ink cartridge installation detection module may determine the operation control on the light emitter required by the acquired emission control instruction by inquiring the mapping relationship between a prestored instruction and the operation control of the light emitter. When the emission control instruction is an on instruction, e.g., “100”, the operation control corresponding to a mapping relationship record “100” is “turning on the light emitter”, and hence the controller turns on the light emitter. When the emission control instruction is an off instruction, e.g., “000”, the operation control corresponding to a mapping relationship record “000” is “turning off the light emitter”, and hence the controller turns off the light emitter. In this case, the controller may include a storage unit for storing the mapping relationships. The storage unit may be an information storage medium, e.g., ROM and FLASH.

Or the above step may be achieved by means of hardware. For instance, the acquired emission control instruction is subjected to logical comparison operation through a custom circuit or an application specific integrated circuit (ASIC) formed by programmable logic devices. Therefore, when the input emission control instruction is an on instruction, e.g., “100”, the circuit outputs high level “1” to the light emitter to turn on the light emitter; and when the emission control instruction is an off instruction, e.g., “000”, the circuit outputs low level “0” to the light emitter to turn off the light emitter. In this case, all or partial units in the controller may be integrated into a logical operation circuit.

After the light emitter is turned on, the light receiver of the inkjet recording apparatus receives light emitted by the light emitter. An optional implementation is that: when the light intensity of the light received by the light receiver satisfies a default condition, the control circuit of the inkjet recording apparatus will determine that the current ink cartridge, the position of which is relative to the light receiver, is correctly mounted, and at this point may indicate the ink cartridge installation detection module to turn off the light emitter; subsequently, the control circuit of the inkjet recording apparatus drives the carriage to move the next ink cartridge to the position relative to the light receiver and generates and sends an installation detection instruction; and the ink cartridge installation detection module repeats the above steps 51 to 53; and the whole ink cartridge installation detection process is completed until the control circuit determines that all the ink cartridges are correctly mounted.

As illustrated in FIG. 2a, when the control circuit of the inkjet recording apparatus receives the ink cartridge installation reply responses fed back by the 5 ink cartridges respectively in the installation reply process, the control circuit continues to execute the emission detection process; or else, the control circuit outputs error information and does not continue to execute the emission detection process.

In the emission detection process, the control circuit drives the carriage to move the ink cartridge a to a position relative to the light receiver and executes emission detection on the ink cartridge a.

The emission detection process executed on the ink cartridge a includes: the control circuit generates an ink cartridge installation detection instruction including identifying information and on instruction of the ink cartridge a. After the ink cartridge installation detection module performs response processing as shown in FIG. 5 on the installation detection instruction, the light emitter is in the on state. The light receiver receives light emitted by the light emitter. When the light intensity of the light received by the light receiver does not satisfies a default condition, the control circuit will determine that the ink cartridge a is mounted at a wrong position and output a warning message, and does not continue to execute the emission detection process of other ink cartridges. When the light intensity of the received light satisfies the default condition, the control circuit will determine that the ink cartridge a is mounted at a correct position and generate an ink cartridge installation detection instruction including identifying information and an off instruction of the ink cartridge a. After the ink cartridge installation detection module performs response processing as shown in FIG. 5 on the installation detection instruction, the light receiver is in the off state.

The control circuit drives the carriage to move the ink cartridge b to a position relative to the light receiver and executes emission detection on the ink cartridge b. When the control circuit determines that the ink cartridge b is mounted at a correct position, the control circuit continues to drive the carriage to move the ink cartridge c to a position relative to the light receiver and executes emission detection on the ink cartridge c; and the process is continued until the emission detection of all the ink cartridge is completed.

The emission detection process executed on the ink cartridges b, c, d and e is similar to the emission detection process executed on the ink cartridge a, with the difference as follows: the ink cartridge identifying information in the ink cartridge installation detection instruction is respectively identifying information of the ink cartridge b, c, d or e. But the ink cartridge installation detection module in the embodiment does not care about the ink cartridge identifying information, that is to say, no matter that the ink cartridge identifying information in the ink cartridge installation detection instruction is the identifying information of which ink cartridge among the 5 ink cartridges, as long as the ink cartridge installation detection instruction includes the emission control instruction, the controller of the ink cartridge installation detection instruction will turn on or off the light emitter according to the emission control instruction.

As known from the above analysis, the embodiment does not need to change the installation detection process of the inkjet recording apparatus but divides the whole ink cartridge installation detection process into the installation reply process and the emission detection process, wherein the installation reply process is the same with that of the prior art; and in the emission detection process, the ink cartridge installation detection module replaces the ink cartridges to respond to the installation detection instructions of the inkjet recording apparatus. The embodiment not only satisfies the inherent ink cartridge installation detection requirement of the inkjet recording apparatus but also allows ink cartridges incapable of responding to the ink cartridge installation detection instructions to be adapted to the inkjet recording apparatus. Therefore, the universality of the ink cartridges can be improved; the selection range of the ink cartridges adapted to the inkjet recording apparatus can be widened; and the use cost of the users can be reduced. Moreover, as the ink cartridge installation detection module can be reutilized, the resource utilization rate can be improved and the cost can be reduced.

It should be understood by those skilled in the art that partial technical proposals in the overall technical proposals provided by the embodiment, e.g., technical proposals relevant to the ink cartridge assembly, the ink cartridge installation module as shown in FIG. 3, and the ink cartridge installation detection method as shown in FIG. 5, may also be implemented as independent technical proposals according to actual requirements, so no further description will be given here.

### Embodiment 2

FIG. 7 is a schematic structural view of another ink cartridge installation detection module provided by the present invention. The differences between the ink cartridge installation detection module as shown in FIG. 7 and the ink cartridge installation detection module as shown in FIG. 3 are as follows:

The controller 222 further includes a storage unit 2224 which may be configured to store a quantity of ink cartridge identifying information.

The receiving unit 2221 is also configured to receive an ink cartridge installation reply request sent by the inkjet recording apparatus before receiving the ink cartridge installation detection instruction. The ink cartridge installation reply request includes ink cartridge identifying information of an ink cartridge which must respond to the ink cartridge installation reply request.

The processing unit 2222 is also configured to compare the ink cartridge identifying information in the ink cartridge installation reply request with the plurality of prestored identifying information.

The control unit 2223 is also configured to send an ink cartridge installation reply response to the inkjet recording apparatus if the comparison result indicates that the plurality of prestored identifying information includes the ink cartridge identifying information in the ink cartridge installation reply request.

The storage unit may be a storage medium such as ROM and FLASH; or the storage unit may be integrated into a logical operation circuit with other units of the controller, e.g., the processing unit.

In the embodiment, as the plurality of ink cartridge information is stored in the ink cartridge installation detection module, the ink cartridge installation detection module may also replace the ink cartridges to perform response processing on the installation reply process apart from performing response processing on the emission detection process as shown in FIG. 5. In this case, the two-way interaction between the ink cartridge installation detection module and the control circuit of the inkjet recording apparatus is involved in the ink cartridge installation detection process. An example of the interactive mode is as shown in FIG. 8.

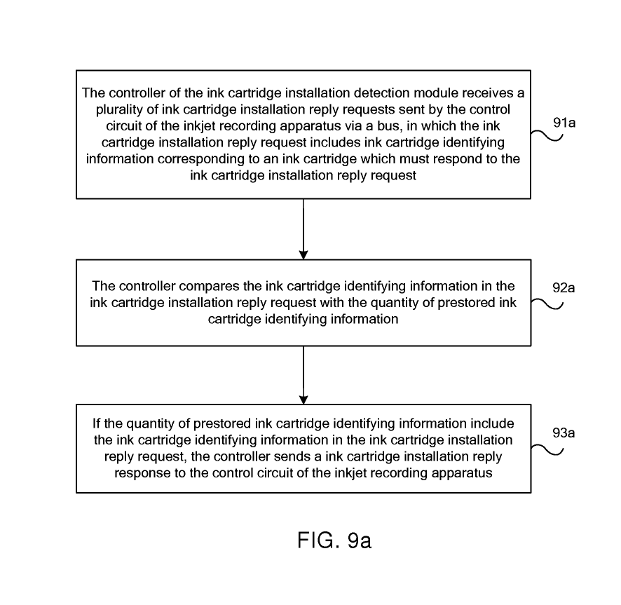

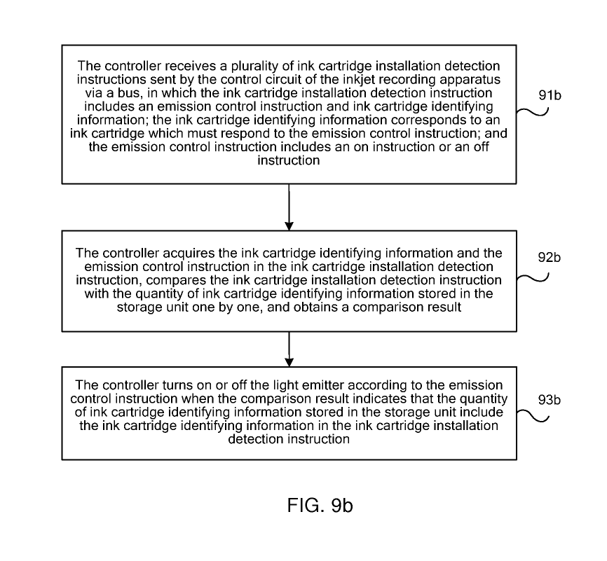

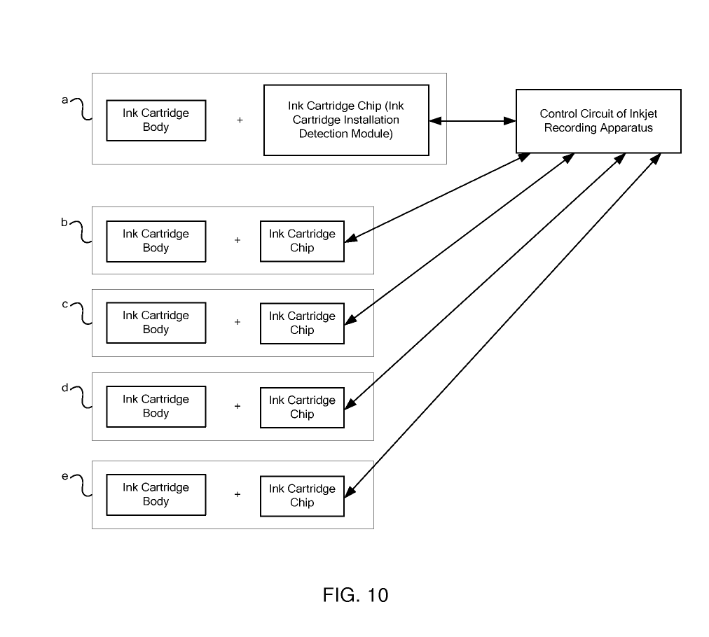

More specifically, as illustrated in FIG. 9a, the principle of the ink cartridge installation detection module in performing installation reply response processing is as follows:

Step 91a: The controller of the ink cartridge installation detection module receives a plurality of ink cartridge installation reply requests sent by the control circuit of the inkjet recording apparatus via a bus. The ink cartridge installation reply request includes ink cartridge identifying information corresponding to an ink cartridge which must respond to the ink cartridge installation reply request.
The ink cartridge identifying information is any identifying information of the ink cartridge which must respond to the ink cartridge installation reply request, e.g., the ink cartridge ID, the ink color identifier of the ink cartridge, and the type identifier of the ink cartridge.

Step 92a: The controller compares the ink cartridge identifying information in the ink cartridge installation reply request with the quantity of prestored ink cartridge identifying information.
In actual application, the ink cartridge identifying information of the ink cartridges in the ink cartridge assembly may be taken as the plurality of prestored identifying information.

Step 93a: If the quantity of prestored ink cartridge identifying information include the ink cartridge identifying information in the ink cartridge installation reply request, the controller sends the ink cartridge installation reply response to the control circuit of the inkjet recording apparatus.

As illustrated in FIG. 2a, the default identifying information may be respective ink cartridge identifying information of the 5 ink cartridges a, b, c, d and e. The ink cartridge identifying information in the ink cartridge installation reply requests sent by the control circuit may be respective ink cartridge identifying information of the 5 ink cartridges a, b, c, d and e. In the prior art, the 5 ink cartridges respectively respond to the ink cartridge installation reply requests; and the ink cartridge will send an ink cartridge installation reply response to the control circuit only when the ink cartridge identifying information in the ink cartridge installation reply request includes the ink cartridge identifying information of the ink cartridge. The difference with the prior art is that: in the embodiment, the responses for the ink cartridge installation reply requests are carried out by the ink cartridge detection module; and the response trigger condition is that: the ink cartridge detection module will send the ink cartridge installation reply response to the control circuit as long as the default identifying information includes the ink cartridge identifying information in the ink cartridge installation reply request.

When the inkjet recording apparatus receives the ink cartridge installation reply response corresponding to respective ink cartridge identifying information in the ink cartridge installation reply request, the inkjet recording apparatus continues to execute the emission detection process; or else, the inkjet recording apparatus outputs a warning message and does not continue to execute the emission detection process.

In the embodiment, the ink cartridge installation detection module performs response processing on the emission detection process. The technical proposal of the ink cartridge installation detection module in performing response processing on the emission detection process may adopt the method as illustrated in the embodiment 1, or may adopt the following replaceable optional proposal.

In the replaceable optional proposal, the processing unit 2222 may be specifically configured to acquire the ink cartridge identifying information and the emission control instruction in the ink cartridge installation detection instruction, compares the ink cartridge installation detection instruction with the quantity of ink cartridge identifying information stored in the storage unit one by one, and obtains a comparison result. The control unit 2223 may be specifically configured to turn on or off the light emitter according to the emission control instruction when the comparison result indicates that the quantity of ink cartridge identifying information stored in the storage unit include the ink cartridge identifying information in the ink cartridge installation detection instruction.

When the number of the light emitters is numerous, optionally, the storage unit 2224 is also configured to store mapping relationships between the plurality of light emitters and the quantity of ink cartridge identifying information; the control unit 2223 is specifically configured to turn on or off the light emitter corresponding to the ink cartridge identifying information in the ink cartridge installation detection instruction according to the emission control instruction and the mapping relationship when the comparison result indicates that the quantity of ink cartridge identifying information stored in the storage unit include the ink cartridge identifying information in the ink cartridge installation detection instruction.

In the replaceable optional proposal, as illustrated in FIG. 9b, the principle of the ink cartridge installation detection module in performing emission detection process is as follows:

Step 91b: The controller receives a plurality of ink cartridge installation detection instructions sent by the control circuit of the inkjet recording apparatus via a bus. The ink cartridge installation detection instruction includes an emission control instruction and ink cartridge identifying information; the ink cartridge identifying information corresponds to an ink cartridge which must respond to the emission control instruction; and the emission control instruction includes an on instruction or an off instruction.

Step 92b: The controller acquires the ink cartridge identifying information and the emission control instruction in the ink cartridge installation detection instruction, compares the ink cartridge installation detection instruction with the quantity of ink cartridge identifying information stored in the storage unit, and obtains a comparison

Step 93b: The controller turns on or off the light emitter when the comparison result indicates that the quantity of ink cartridge identifying information stored in the storage unit include the ink cartridge identifying information in the ink cartridge installation detection instruction.

When the emission control instruction is an on instruction, the controller turns on the light emitter; and when the emission control instruction is an off instruction, the controller turns off the light emitter.

The controller repeats the above steps 92b and 93b when receiving an ink cartridge installation detection instruction each time.

When the number of the light emitters is numerous, the controller may prestore mapping relationships between the plurality of light emitters and the quantity of ink cartridge identifying information, and turns on or off the light emitter corresponding to the ink cartridge identifying information in the ink cartridge installation detection instruction according to the emission control instruction and the mapping relationship when the comparison result indicates that the quantity of ink cartridge identifying information stored in the storage unit include the ink cartridge identifying information in the ink cartridge installation detection instruction.

As known from the above analysis, the embodiment does not need to change the installation detection process of the inkjet recording apparatus but adopt the ink cartridge installation detection module to replace the ink cartridges to respond to the whole ink cartridge installation detection process. The embodiment not only satisfies the inherent ink cartridge installation detection requirement of the inkjet recording apparatus but also allows ink cartridges incapable of responding to the ink cartridge installation detection instruction to be adapted to the inkjet recording apparatus. Therefore, the universality of the ink cartridges can be improved; the selection range of the ink cartridges adapted to the inkjet recording apparatus can be widened; and the use cost of the users can be reduced. Moreover, as the ink cartridge installation detection module can be reutilized, the resource utilization rate can be improved and the cost can be reduced.

It should be understood by those skilled in the art that partial technical proposals in the overall technical proposals provided by the embodiment, e.g., the ink cartridge installation module as shown in FIG. 7 and the ink cartridge installation detection method as shown in FIG. 8, may also be implemented as independent technical proposals according to actual requirements, so no further description will be given here.

### Embodiment 3

In the embodiment, the ink cartridge installation detection module may be mounted on a housing of an ink cartridge assembly body or an ink cartridge. A hardware entity of the ink cartridge installation detection module may be an integrated circuit (IC) chip. The hardware integrated deployment mode of the ink cartridge chip and the ink cartridge installation detection module is very flexible.

In an optional implementation, the ink cartridge installation detection module may be integrated into a whole with an ink cartridge chip of any ink cartridge. As illustrated in FIG. 2a, the ink cartridge installation detection module may be integrated into a whole with an ink cartridge chip of the ink cartridge a. The ink cartridges b, c, d and e have respective ink cartridge chip. In this case, as illustrated in FIG. 10, the interactive mode in the ink cartridge installation detection process is equivalent to the two-way interaction between the ink cartridge chips of the ink cartridges and the control circuit of the inkjet recording apparatus in the ink cartridge installation process.

Optionally, the ink cartridge chips of the ink cartridges may be detachably connected with ink cartridge bodies of the ink cartridges. For instance, the ink cartridge chips of the ink cartridges may be correspondingly arranged in ink cartridge accommodating areas of the housing as shown in FIG. 2b. When ink of any ink cartridge runs out, only the ink cartridge body of the ink cartridge is disassembled and replaced, and hence the cost can be reduced.

In another optional implementation, the ink cartridges are not required to be provided with ink cartridge chips independently but share a common chip. The ink cartridges are detachably connected with the common chip. When the ink in the ink cartridge runs out and replacement is required, the common chip may be reutilized and is not required to be replaced, and hence the cost can be reduced.

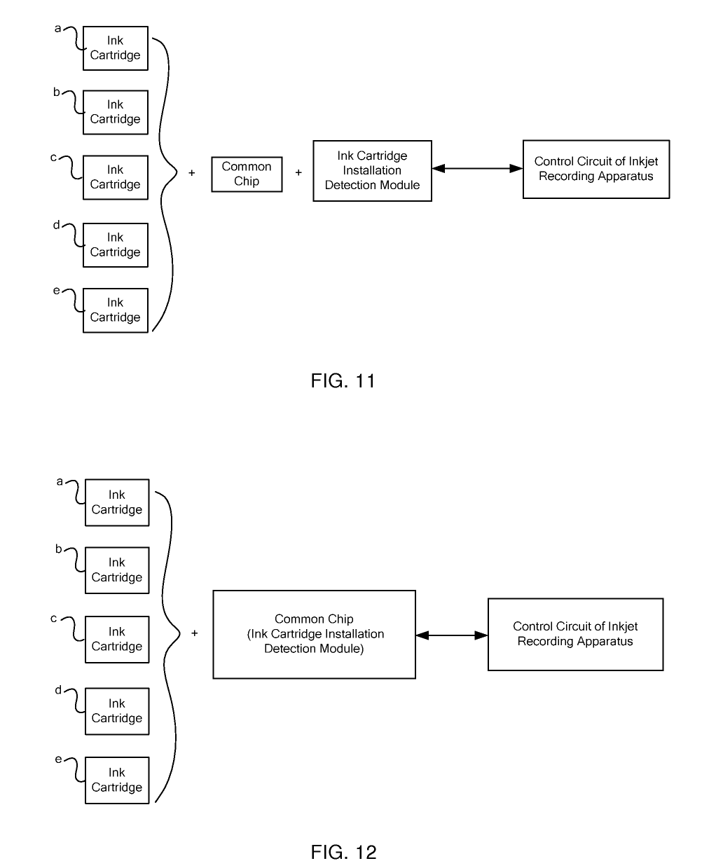

In this case, the ink cartridge installation detection module may be separately arranged with the common chip. As illustrated in FIG. 11, the interactive mode in the ink cartridge installation detection process as illustrated in the embodiment 2 is equivalent to the two-way interaction between the ink cartridge installation detection module and the control circuit of the inkjet recording apparatus. Or the ink cartridge installation detection module may be integrated into a whole with the common chip. As illustrated in FIG. 12, the interactive mode in the ink cartridge installation detection process as illustrated in the embodiment 2 is equivalent to the two-way interaction between the common chip and the control circuit of the inkjet recording apparatus in the ink cartridge installation detection process.

Moreover, optionally, the common chip which is integrally or separately arranged with the ink cartridge installation detection module may be disposed on the housing in the ink cartridge assembly body. When ink of any ink cartridge runs out, only the ink cartridge is disassembled for replacement, and hence the cost can be reduced.

In addition, it should be understood by those skilled in the art that: as for a single ink cartridge, the ink cartridge may include an ink cartridge body and an ink cartridge chip, and the ink cartridge installation detection module is detachably mounted on the ink cartridge body; or the ink cartridge installation detection module and the ink cartridge chip are integrated into a whole and detachably mounted on the ink cartridge body. As the ink cartridge is provided with the ink cartridge installation detection module, the universality of the ink cartridge can be improved. Moreover, as the ink cartridge installation detection module can be reutilized, the production efficiency of the ink cartridge can be improved and the production cost of the ink cartridge and the use cost of the users can be reduced.

### Embodiment 4

In the ink cartridge installation detection process, the control circuit of the inkjet recording apparatus may consider the light intensity of the light actually received by the light receiver while determining whether the ink cartridge is mounted at a correct position. When the light intensity of the light actually received by the light receiver is weaker and less than a default threshold, the control circuit outputs a warning message. In some situation, there may be the case that the ink cartridge is mounted at the correct position actually but the light intensity of the light received by the light receiver is weaker, and hence the ink cartridge installation detection is unsuccessful and the user cannot perform subsequent print operation.

In order to reduce the probability of the above phenomenon, when only one light-emitting portion is arranged, a light source with larger luminous brightness may be selected as the light emitter, and an elongated light source may also be selected as the light emitter; or when a plurality of light emitters are arranged, the controller of the ink cartridge installation detection module turns on or off the plurality of light emitters simultaneously, so as to increase the light intensity of light entering the light receiver.

In addition, the position arrangement of the light emitters in the ink cartridge assembly body is very flexible. For instance, the light emitters may be intensively arranged on any ink cartridge, or the plurality of light emitters may be dispersedly arranged on the plurality of ink cartridges.

When only one light emitter is arranged, the ink cartridge installation detection module further comprises an optical transmitter provided with at least two openings. The positions of the openings correspond to mounting positions of the ink cartridges. The optical transmitter is configured to transmit the light emitted by the light emitter through the openings.

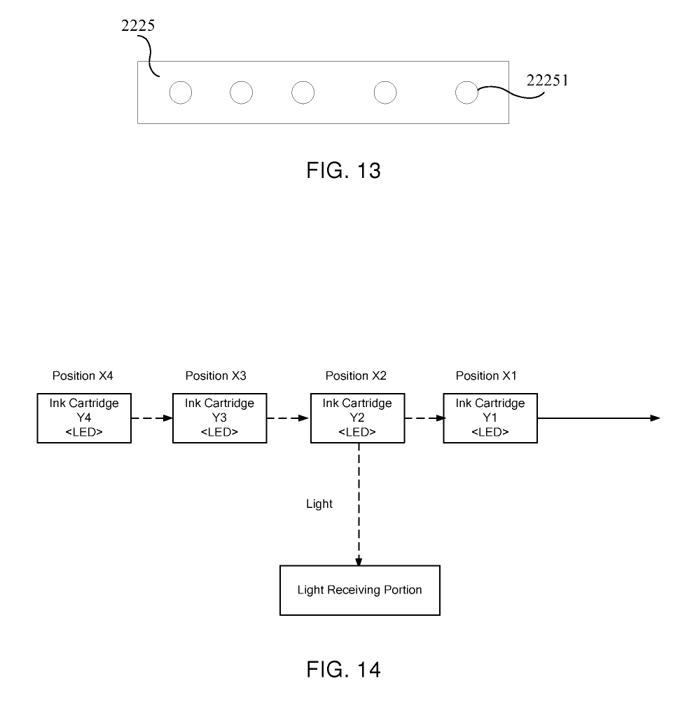

An optional structure of the optical transmitter is as illustrated in FIG. 13. Taking the matching of the ink cartridge assemblies as shown in FIGS. 2a and 2b as an example, the optical transmitter 2225 as shown in FIG. 13 is provided with 5 openings 22251 which respectively correspond to the ink cartridge accommodating areas A, B, C, D and E as shown in FIG. 2b. In the case of the installation detection of any ink cartridge, the light emitted by the light emitter may be transmitted from an opening corresponding to a mounting position of the ink cartridge accommodating area of the ink cartridge, and hence received by the light receiver; and light transmitted from other openings may be replenished, and hence the light intensity of the light received by the light receiver can be increased.

The optical transmitter may include any optical transmission medium, e.g., including an optical fiber or other medium which utilizes the total reflection principle for transmission. Optionally, the optical transmitter may also be designed to be a structure with convergent or reflective function, so as to reduce the attenuation of light in the transmission process and increase the light intensity of light transmitted through the openings.

When the number of the light emitters is numerous, optionally, the number of the optical transmitter may be one or more. In an optional implementation, if both the number of the light emitter and the number of the optical transmitter are numerous, both the plurality of light emitters and the plurality of optical transmitters are arranged on certain ink cartridge; the plurality of optical transmitters are arranged into different lengths according to the distance between each ink cartridge and the ink cartridge on which the optical transmitters are arranged, so as to guide corresponding light to a corresponding position at which each ink cartridge is relative to the light receiver; and the optical transmitters are configured to guide the light emitted by respective corresponding light emitters to the light receiver. The above mode is very conducive to prevent the optical interference on certain printers.

Optionally, in the above mode, the controller may be one or more.

When the controller is one but the number of the light emitters is numerous, the control of one controller to the plurality of light emitters is as shown in the embodiment 1 or 2.

When both the number of the controllers and the number of the light emitters are numerous, the controllers and the light emitters may be in one-to-one correspondence. Optionally, in this case, the plurality of light emitters may be intensively arranged on any ink cartridge. The control of each controller to the corresponding light emitter may be as shown in the embodiment 1 or 2.

In summary, in the initialization process of the inkjet recording process of the present invention, the ink cartridge installation detection module replaces the specific ink cartridges to respond to all or partial instructions, relevant to the ink cartridge installation detection, sent by the inkjet recording apparatus, so that the present invention not only satisfies the inherent ink cartridge installation detection requirement of the inkjet recording apparatus but also allows ink cartridges without the ability of responding the installation detection relevant instructions to be adapted to the inkjet recording apparatus. Therefore, the universality of the ink cartridges can be improved; the selection range of ink cartridges adapted to the inkjet recording apparatus can be widened; and the use cost of the users can be reduced. Moreover, as the ink cartridge installation detection module may be reutilized, the resource utilization can be improved and the cost can be reduced. In addition, the hardware deployment mode of the ink cartridge installation detection module and the ink cartridge chip is very flexible. The ink cartridge installation detection module and the ink cartridge chip may be detachably connected with the ink cartridge body, and hence the resource utilization rate of the ink cartridge installation detection module and the ink cartridge chip can be improved and the cost can be further reduced.

In the above embodiments, the description of respective embodiments has emphasis, and parts without detailed description in certain embodiment may refer to relevant description of other embodiments.

Moreover, functional units in the embodiments of the present invention may be integrated in a unit and may also exist independently and physically; or two or more than two functional units are integrated in a unit. The integrated unit may be implemented by means of hardware and may also be implemented by means of a hardware and software functional unit.

It should be understood by those skilled in the art that: all or partial steps for implementing the method embodiments may be completed by hardware relevant to program instructions. The foregoing program may be stored in a computer-readable storage medium. The program executes the steps of the method embodiments in the process of execution. The foregoing storage medium includes various media capable of storing program codes, e.g., ROM, RAM, discs and CD.

It should be finally noted that the foregoing embodiments are only illustrative of the technical proposals of the present invention and not intended to limit the present invention. Although detailed description has been given to the present invention with reference to the foregoing embodiments, it should be understood by those skilled in the art that: modification may be still made to the technical proposals of the foregoing embodiments and equivalent replacement may be still made to partial or all the technical characteristics therein, by those skilled in the art; and the modifications or replacements should not allow the essence of corresponding technical proposals to depart from the scope of the technical proposals of the embodiments of the present invention.

What is claimed is:

1. An ink cartridge installation detection module, comprising:
a light emitter configured to provide a light source; and
a controller including a receiving unit, a processing unit and a control unit, in which the receiving unit is configured to receive a plurality of ink cartridge installation detection instructions sent by an inkjet recording apparatus via a bus; the ink cartridge installation detection instruction includes an emission control instruction and ink cartridge identifying information; the ink cartridge identifying information corresponds to an ink cartridge which must respond to the emission control instruction; the emission control instruction includes an on instruction or an off instruction; the processing unit is configured to analyze the ink cartridge installation detection instruction; and the control unit is configured to turn on or off the light emitter according to the analytic result of the processing unit.

2. The module according to claim 1, wherein
the processing unit is specifically configured to analyze a part in the ink cartridge installation detection instruction, used for carrying the emission control instruction, so as to acquire the emission control instruction; and
the control unit is specifically configured to turn on or off the light emitter according to the emission control instruction.

3. The module according to claim 1, further comprising:
a storage unit configured to store a quantity of ink cartridge identifying information.

4. The module according to claim 3, wherein
the processing unit is specifically configured to acquire the ink cartridge identifying information and the emission control instruction in the ink cartridge installation detection instruction and obtain a comparison result by progressively comparing the ink cartridge installation detection instruction with the quantity of ink cartridge identifying information stored in the storage unit; and
the control unit is specifically configured to turn on or off the light emitter according to the emission control instruction when the comparison result indicates that the plurality of ink cartridge identifying information stored in the storage unit include the ink cartridge identifying information in the ink cartridge installation detection instruction.

5. The module according to claim 4, wherein
the storage unit is an information storage medium; or
the storage unit and the processing unit are integrated into a logical operation circuit.

6. The module according to claim 4, further comprising: an optical transmitter, wherein
the number of the light emitter is one; and
the optical transmitter is provided with at least two openings and configured to transmit light emitted by the light emitter via the openings.

7. The module according to claim 4, wherein
the number of the light emitters is numerous; and
the control unit is specifically configured to turn on or off the plurality of light emitters at the same time according to the emission control instruction.

8. The module according to claim 4, wherein
the number of the light emitters is numerous;
the storage unit is also configured to store mapping relationships between the plurality of light emitters and the quantity of ink cartridge identifying information; and
the control unit is specifically configured to turn on or off the light emitter corresponding to the ink cartridge identifying information in the ink cartridge installation detection instruction according to the emission control instruction and the mapping relationship when the comparison result indicates that the quantity of ink cartridge identifying information stored in the storage unit include the ink cartridge identifying information in the ink cartridge installation detection instruction.

9. An ink cartridge assembly, comprising an ink cartridge assembly body including at least two ink cartridge, wherein the ink cartridge assembly further comprises:
the ink cartridge installation detection module according to any one of claims 1; and
the ink cartridge installation detection module is detachably mounted on the ink cartridge assembly body.

10. The ink cartridge assembly according to claim 9, wherein
the ink cartridge assembly body further includes: a housing; the at least two ink cartridges are detachably mounted in the housing; and
the ink cartridge installation detection module is detachably mounted on the housing or the ink cartridges.

11. The ink cartridge assembly according to claim 10, wherein
when the ink cartridge installation detection module includes a plurality of light emitters, the plurality of light emitters are detachably and intensively mounted on any ink cartridge or detachably and dispersedly mounted on the at least two ink cartridges.

12. The ink cartridge assembly according to claim 10, wherein
the ink cartridge includes: an ink cartridge body and an ink cartridge chip detachably mounted on the ink cartridge body; and
the ink cartridge installation detection module and the ink cartridge chip of any ink cartridge are integrated into a whole.

13. The ink cartridge assembly according to claim 10, wherein the ink cartridge assembly body further includes: a common chip of the ink cartridges;
the common chip is detachably connected with the ink cartridges; and
the ink cartridge installation detection module and the common chip are separately or integrally arranged.

14. The ink cartridge assembly according to claim 10, wherein when the ink cartridge installation detection module includes a light emitter and an optical transmitter, positions of the openings of the optical transmitter correspond to mounting positions of the ink cartridges.

15. An ink cartridge installation detection method, comprising:
receiving a plurality of ink cartridge installation detection instructions sent by an inkjet recording apparatus via a bus, in which the ink cartridge installation detection instruction includes an emission control instruction and ink cartridge identifying information; the ink cartridge identifying information corresponds to an ink cartridge which must respond to the emission control instruction; the emission control instruction includes an on instruction or an off instruction;
analyzing the ink cartridge installation detection instruction; and
turning on or off a light emitter according to the analytic result.

16. The method according to claim 15, wherein
the step of analyzing the ink cartridge installation detection instruction includes: analyzing a part in the ink cartridge installation detection instruction, used for carrying the emission control instruction, so as to acquire the emission control instruction; and
the step of turning on or off the light emitter according to the analytic result includes: turning on or off the light emitter according to the emission control instruction.

17. The method according to claim 15, further comprising:
prestoring a quantity of ink cartridge identifying information.

18. The method according to claim 16, wherein when the number of the light emitters is numerous, the step of turning on or off the light emitter includes:
turning on or off the plurality of light emitters according to the emission control instruction.

19. The method according to claim 18, wherein
the method further comprises: prestoring mapping relationships between the plurality of light emitters and the quantity of ink cartridge identifying information when the number of the light emitters is numerous; and
the step of analyzing the ink cartridge installation detection instruction includes: acquiring the ink cartridge identifying information and the emission control instruction in the ink cartridge installation detection instruction, and obtaining a comparison result by progressively comparing the ink cartridge installation detection instruction with the quantity of ink cartridge identifying information;
the step of turning on or off the light emitter according to the analytic result includes: turning on or off the light emitter corresponding to the ink cartridge identifying information in the ink cartridge installation detection instruction according to the emission control instruction and the mapping relationship when the comparison result indicates that the quantity of ink cartridge identifying information include the ink cartridge identifying information in the ink cartridge installation detection instruction.
